(19) United States
(12) Patent Application Publication
(10) Pub. No.: US 2015/0263397 A1
(43) Pub. Date: Sep. 17, 2015

(54) SIDE MOUNTED TRACTION BATTERY THERMAL PLATE

(71) Applicant: Ford Global Technologies, LLC, Dearborn, MI (US)

(72) Inventors: Suriyaprakash Ayyangar Janarthanam, Westland, MI (US); Bhaskara Boddakayala, Canton, MI (US); Saravanan Paramasivam, South Lyon, MI (US); Sai K. Perumalla, Rochester Hills, MI (US)

(73) Assignee: Ford Global Technologies, LLC, Dearborn, MI (US)

(21) Appl. No.: 14/208,416

(22) Filed: Mar. 13, 2014

(51) Int. Cl. H01M 10/6554

(52) U.S. Cl. CPC H01M 10/5053

(57) ABSTRACT

A battery assembly may include an array of battery cells each having upper and lower ends, a face extending therebetween and partially defining an exterior of the array, and terminals extending from the upper end. The battery assembly may also include an exo-support structure including a plurality of retainer segments configured to support the upper and lower ends and a thermal plate defining one or more channels extending along the exterior of the array. The thermal plate may be arranged to thermally communicate with the battery cells via the faces. The exo-support structure may further include another thermal plate defining one or more channels extending along another exterior of the array which are arranged to thermally communicate with the cells. The battery assembly may include at least one cell separator made of a thermally conductive material which is located between two adjacent cells.

### TECHNICAL FIELD

This disclosure relates to thermal management systems for high voltage batteries utilized in vehicles.

### BACKGROUND

Vehicles such as battery-electric vehicles (BEVs), plug-in hybrid-electric vehicles (PHEVs) or full hybrid-electric vehicles (FHEVs) contain a traction battery, such as a high voltage (“HV”) battery, to act as a propulsion source for the vehicle. The HV battery may include components and systems to assist in managing vehicle performance and operations. The HV battery may include one or more arrays of battery cells interconnected electrically between battery cell terminals and interconnector busbars. The HV battery and surrounding environment may include a thermal management system to assist in managing temperature of the HV battery components, systems, and individual battery cells.

### SUMMARY

A battery assembly includes an array of battery cells each having upper and lower ends, a face extending therebetween and partially defining an exterior of the array, and terminals extending from the upper end. The battery assembly also includes an exo-support structure including a plurality of retainer segments configured to support the upper and lower ends and a thermal plate defining one or more channels extending along the exterior of the array and arranged to thermally communicate with the battery cells via the faces. The battery assembly may further include a thermal interface layer disposed between and in contact with the faces and the thermal plate. The thermal plate may directly contact the faces of the battery cells. At least one of the retainer segments may define a segment channel therein which extends along a portion of the upper and lower ends that does not include the faces. Each of the battery cells may have another face extending between the upper and lower ends, opposite the other face, and partially defining another exterior of the array, and the exo-support structure may further include another thermal plate defining one or more channels extending along the another exterior of the array which are arranged to thermally communicate with the cells via the another face. The battery assembly may include at least one cell separator made of a thermally conductive material which is located between two adjacent cells. The cell separator may be configured to contact the two adjacent cells at portions of the cells on three sides which do not include the upper and lower ends and may be configured to dissipate heat therefrom. The thermally conductive material may be made of ceramic doped high density polyethylene or polypropylene, or of an aluminum coated with ceramics or laminated film.

A vehicle includes a battery cell array having two side portions and two thermal plates, each in thermal communication with the battery cell array on opposite side portions of the array and each defining a plurality of substantially horizontal channels relative to the array therein. The vehicle also includes an extension plate including at least one extension plate channel in fluid communication with at least one of the substantially horizontal channels. The vehicle also includes a heat generating module in electrical communication with the array and secured to the extension plate and in thermal communication therewith. The vehicle also includes an exo-support structure configured to support the array and to house and orient the thermal plates such that each of the substantially horizontal channels extends along a length of one of the side portions of the array. The vehicle may include a thermal interface layer disposed between and in contact with at least one of the side portions and thermal plates. At least one cell separator made of a thermally conductive material may be located between two adjacent battery cells and configured to contact three sides of one of the battery cells such that heat is dissipated therefrom and toward the thermal plates. The exo-support structure may define a plurality of retainer segments configured to support the array and the retainer segments may define at least one retainer channel therein. The at least one retainer channel may extend along a portion of an upper or lower end of the array. The vehicle may also include a battery tray configured to support the first and second support structures. A bottom portion of the array, the support structures, and the battery tray may define a cavity such that air may flow underneath the array. The thermal plates may define inlets in communication with the channels and the thermal plates may be arranged such that the inlets are at opposite ends of the array.

A battery thermal management system includes a battery cell array including battery cells, two thermal plates located on either side of the array, and an exo-support structure configured to house the two thermal plates and to support the array. The thermal plates each define an inlet port and an outlet port positioned at opposite ends of the respective thermal plate, and a plurality of channels each including an inlet in communication with the inlet port and an outlet in communication with the outlet port. The exo-support structure is configured to house the two thermal plates and to support the array. The thermal plates and the exo-support structure are arranged such that the channels extend along a width of each outer face of the battery cells and are substantially perpendicular to a height of the array. One of the thermal plates may further define an extension plate including a plurality of extension plate channels in fluid communication with at least one of the plurality of channels and configured to thermally communicate with a heat generating module secured thereto. The battery thermal management system may also include another battery cell array supported by the exo-support structure and arranged with the other battery cell array such that one of the thermal plates is arranged therebetween and in thermal communication with both battery cell arrays. A plurality of cell separators made of thermally conductive materials may be located between adjacent battery cells and may be configured to contact three sides of one of the adjacent battery cells and dissipate heat therefrom. The cell separators may be C-shaped or I-shaped. The battery thermal management system may include a cell separator block made of a thermally conductive material and which may be configured to sit within the exo-support structure and define a plurality of slots arranged to receive the battery cells. The exo-support structure may define a plurality of retainer segments configured to support the array and the retainer segments may define at least one retainer channel therein and may be arranged such that the at least one retainer channel extends along a portion of an upper or lower end of the array.

### BRIEF DESCRIPTION OF THE DRAWINGS

FIG. 1 is a schematic illustration of a battery electric vehicle.

FIG. 2 is a perspective view of a portion of a thermal management system for the traction battery of the vehicle in FIG. 1.

FIG. 3 is a perspective view of a traction battery assembly including an exo-support structure for a battery cell array.

FIG. 4 is a plan view of the traction battery assembly from FIG. 3.

FIG. 5 is a perspective view of the battery cell array of the traction battery assembly from FIG. 3.

FIG. 6 is a front view, in cross-section, of a portion of the fraction battery assembly from FIG. 3.

FIG. 7 is a perspective view of a thermal plate portion of the traction battery assembly from FIG. 3.

FIG. 8A is a side view, in cross-section, of the thermal plate from FIG. 7.

FIG. 8B is an illustrative plan view of the traction battery assembly from FIG. 3 showing an example of directions for thermal fluid flow.

FIG. 9 is a perspective view of a portion of a traction battery assembly in which a thermal plate includes a thermal plate extension and a heat generating module.

FIG. 10A is a perspective view of the traction battery assembly from FIG. 3 including another battery cell array and an exo-support structure and FIG. 10B is a front view of FIG. 10A.

FIG. 11A is a plan view of a portion of the traction battery assembly from FIG. 3 with two types of battery cell separators.

FIG. 11B is a perspective view of the two battery cell separators from FIG. 11A.

FIG. 11C is a perspective view of a battery cell separator block for use with the traction battery assembly from FIG. 3.

FIG. 11D is a perspective view of a battery cell separator block for use with cylindrical battery cells.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

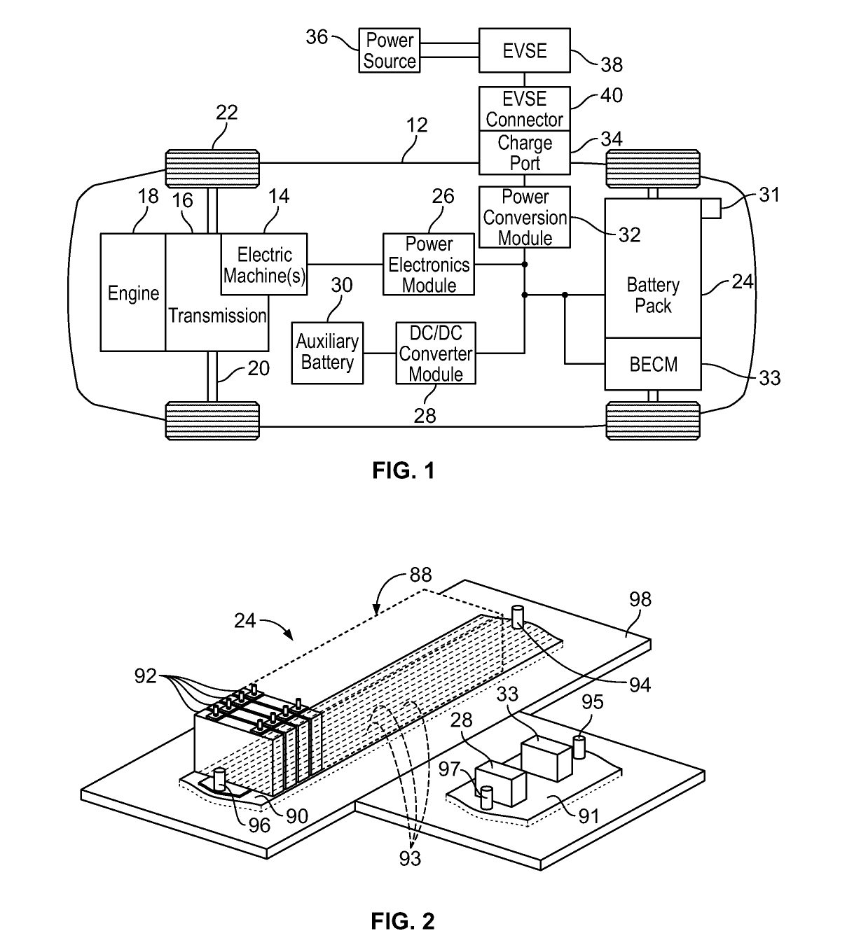

FIG. 1 depicts a schematic of a typical plug-in hybrid-electric vehicle (PHEV). A typical plug-in hybrid-electric vehicle 12 may comprise one or more electric machines 14 mechanically connected to a hybrid transmission 16. The electric machines 14 may be capable of operating as a motor or a generator. In addition, the hybrid transmission 16 is mechanically connected to an engine 18. The hybrid transmission 16 is also mechanically connected to a drive shaft 20 that is mechanically connected to the wheels 22. The electric machines 14 can provide propulsion and deceleration capability when the engine 18 is turned on or off. The electric machines 14 also act as generators and can provide fuel economy benefits by recovering energy that would normally be lost as heat in the friction braking system. The electric machines 14 may also provide reduced pollutant emissions since the hybrid-electric vehicle 12 may be operated in electric mode under certain conditions.

A traction battery or battery pack 24 stores energy that can be used by the electric machines 14. The traction battery 24 typically provides a high voltage DC output from one or more battery cell arrays, sometimes referred to as battery cell stacks, within the traction battery 24. The battery cell arrays may include one or more battery cells. The traction battery 24 is electrically connected to one or more power electronics modules 26 through one or more contactors (not shown). The one or more contactors isolate the traction battery 24 from other components when opened and connect the traction battery 24 to other components when closed. The power electronics module 26 is also electrically connected to the electric machines 14 and provides the ability to bi-directionally transfer electrical energy between the traction battery 24 and the electric machines 14. For example, a typical traction battery 24 may provide a DC voltage while the electric machines 14 may require a three-phase AC voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. The description herein is equally applicable to a pure electric vehicle. For a pure electric vehicle, the hybrid transmission 16 may be a gear box connected to an electric machine 14 and the engine 18 may not be present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle loads. Other high-voltage loads, such as compressors and electric heaters, may be connected directly to the high-voltage without the use of a DC/DC converter module 28. In a typical vehicle, the low-voltage systems are electrically connected to an auxiliary battery 30 (e.g., 12V battery).

A battery electrical control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24.

The vehicle 12 may be, for example, an electric vehicle such as a plug-in hybrid vehicle, or a battery-electric vehicle in which the traction battery 24 may be recharged by an external power source 36. The external power source 36 may be a connection to an electrical outlet. The external power source 36 may be electrically connected to electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus (e.g., Controller Area Network (CAN)) or via discrete conductors.

The battery cells, such as a prismatic cell, a cylindrical cell, or a pouch cell, may include electrochemical cells that convert stored chemical energy to electrical energy. Prismatic cells may include a housing, a positive electrode (cathode) and a negative electrode (anode). An electrolyte may allow ions to move between the anode and cathode during discharge, and then return during recharge. Terminals may allow current to flow out of the cell for use by the vehicle. When positioned in an array with multiple battery cells, the terminals of each battery cell may be aligned with opposing terminals (positive and negative) adjacent to one another and a busbar may assist in facilitating a series connection between the multiple battery cells. The battery cells may also be arranged in parallel such that similar terminals (positive and positive or negative and negative) are adjacent to one another. For example, two battery cells may be arranged with positive terminals adjacent to one another, and the next two cells may be arranged with negative terminals adjacent to one another. In this example, the busbar may contact terminals of all four cells.

The fraction battery 24 may be heated and/or cooled using a liquid thermal management system, an air thermal management system, or other method as known in the art. In one example of a liquid thermal management system and now referring to FIG. 2, the traction battery 24 may include a battery cell array 88 shown supported by a thermal plate 90 to be heated and/or cooled by a thermal management system. The battery cell array 88 may include a plurality of battery cells 92 positioned adjacent to one another. The DC/DC converter module 28, the BECM 33, and/or a charger may also require thermal management under certain operating conditions. A thermal plate 91 may support the DC/DC converter module 28, the BECM 33, and/or the charger and assist in thermal management thereof. For example, the DC/DC converter module 28 may generate heat during voltage conversion which may need to be dissipated. Alternatively, thermal plates 90 and 91 may be in fluid communication with one another to share a common fluid inlet port and common outlet port.

In one example, the battery cell array 88 may be mounted to the thermal plate 90 such that only one surface, of each of the battery cells 92, such as a bottom surface, is in contact with the thermal plate 90. The thermal plate 90 and individual battery cells 92 may transfer heat between one another to assist in managing the thermal conditioning of the battery cell array 88 during vehicle operations. Uniform thermal fluid distribution and high heat transfer capability are two thermal plate 90 considerations for providing effective thermal management of the battery cell arrays 88 and other surrounding components. Since heat transfers between thermal plate 90 and thermal fluid via conduction and convection, the surface area in a thermal fluid flow field is important for effective heat transfer, both for removing heat and for preheating the battery cells 92 at cold temperatures. For example, charging and discharging the battery cells generates heat which may negatively impact performance and life of the battery cell array 88 if not removed. Alternatively, the thermal plate 90 may also provide heat to preheat the battery cell array 88 when subjected to cold temperatures.

The thermal plate 90 may include one or more channels 93 and/or a cavity to distribute thermal fluid through the thermal plate 90. For example, the thermal plate 90 may include an inlet port 94 and an outlet port 96 that may be in communication with the channels 93 for providing and circulating the thermal fluid. Positioning of the inlet port 94 and outlet port 96 relative to the battery cell arrays 88 may vary. For example and as shown in FIG. 2, the inlet port 94 and outlet port 96 may be centrally positioned relative to the battery cell arrays 88. The inlet port 94 and outlet port 96 may also be positioned to the side of the battery cell arrays 88. Alternatively, the thermal plate 90 may define a cavity (not shown) in communication with the inlet port 94 and outlet port 96 for providing and circulating the thermal fluid. The thermal plate 91 may include an inlet port 95 and an outlet port 97 to deliver and remove thermal fluid. Optionally, a sheet of thermal interface material (not shown) may be applied to the thermal plate 90 and/or 91 below the battery cell array 88 and/or the DC/DC converter module 28 and the BECM 33. The sheet of thermal interface material may enhance heat transfer between the battery cell array 88 and the thermal plate 90 by filling, for example, voids and/or air gaps between the battery cells 92 and the thermal plate 90. The thermal interface material may also provide electrical insulation between the battery cell array 88 and the thermal plate 90. A battery tray 98 may support the thermal plate 90, thermal plate 91, battery cell arrays 88, and other components. The battery tray 98 may include one or more recesses to receive thermal plates.

Different battery pack configurations may be available to address individual vehicle variables including packaging constraints and power requirements. The battery cell arrays 88 may be contained within a cover or housing (not shown) to protect and enclose the battery cell arrays 88 and other surrounding components, such as the DC/DC converter module 28 and the BECM 33. The battery cell arrays 88 may be positioned at several different locations including below a front seat, below a rear seat, or behind the rear seat of the vehicle, for example. However, it is contemplated the battery cell arrays 88 may be positioned at any suitable location in the vehicle 12.

Two examples of desired thermal plate deliverables may include (i) extracting a maximum amount of heat from the battery cells and (ii) maintaining a substantially uniform temperature at a base of the battery cells. To achieve these deliverables, a thermal management system may take several considerations into account. For example, a temperature of the battery cell may vary across the cell between a minimum and a maximum temperature which may be referred to as a battery cell delta temperature (“cell ΔT”). In a battery cell array, the temperatures of the battery cells may vary across the battery cell array between a minimum and maximum temperature which may be referred to as a battery cell array delta temperature (“array ΔT”). Lower cell ΔT and array ΔT measurements typically indicate a more uniform temperature distribution throughout the battery cell and battery cell array, respectively. As such, maximizing overall heat transfer efficiency between the battery cell array and thermal plate may assist in minimizing cell ΔT and array ΔT. A desired cell ΔT and a desired array ΔT may vary according to power requirements for different vehicles and thermal management systems.

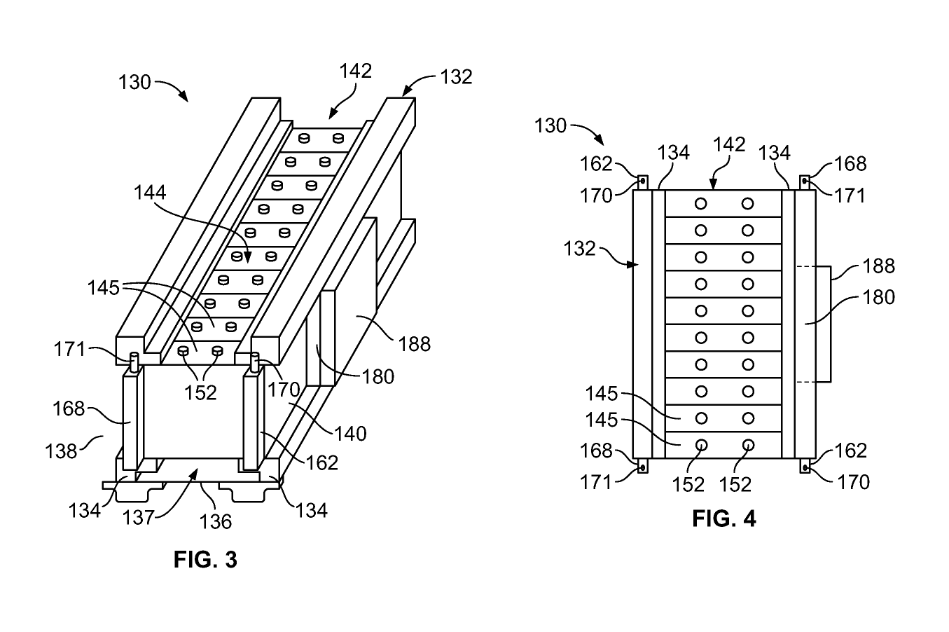

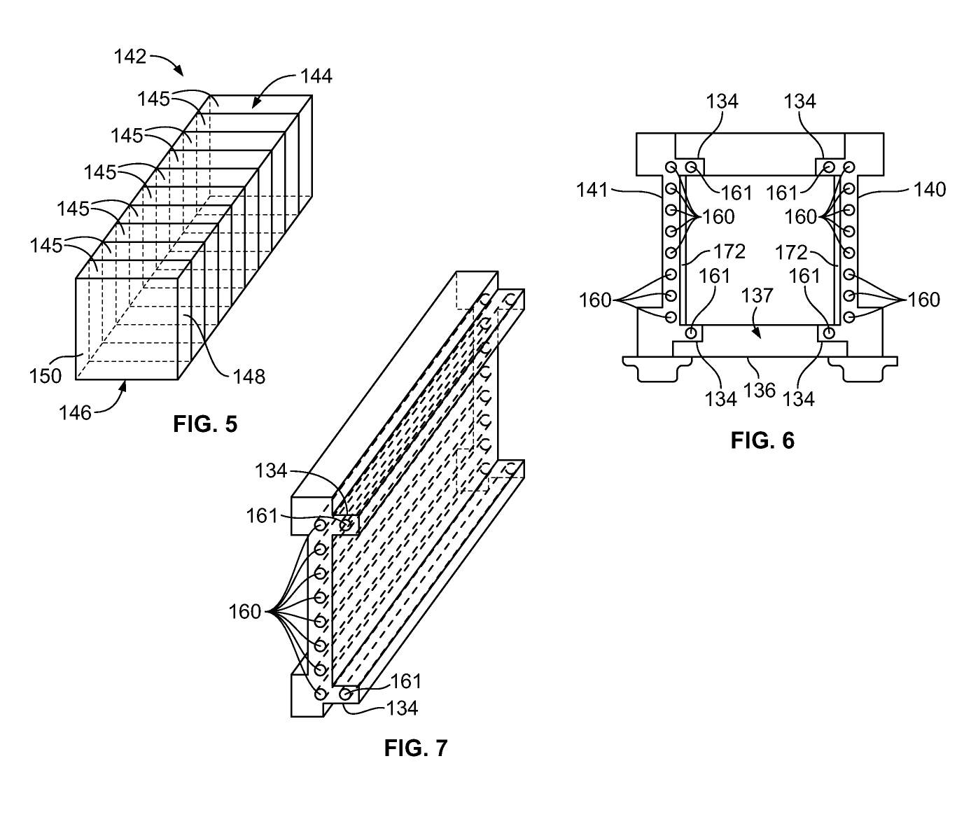

FIGS. 3 through 6 show an example of a traction battery assembly 130 which may include an exo-support structure 132. The exo-support structure 132 may include a plurality of retainer segments 134 and one or more thermal plates. For example, a first thermal plate 140 and a second thermal plate 141 may be secured to, housed within, or defined by the exo-support structure 132. The exo-support structure 132 may be secured to a tray 136. A housing (not shown) may enclose the traction battery assembly 130. The exo-support structure 132 may be configured to support a battery cell array 142. The exo-support structure 132, the battery cell array 142, and the tray 136 may define a cavity 137 therebetween. The battery cell array 142 may have an upper end 144, a lower end 146, and include a plurality of battery cells 145. The upper end 144 and the lower end 146 may define a first face 148 and a second face 150 for each of the battery cells 145 therebetween. The first face 148 and second face 150 may partially define an exterior of the battery cell array 142. Terminals 152 may extend upwardly from the upper end 144 of the battery cell array 142. The retainer segments 134 may be configured to support the battery cell array 142 at the upper end 144 and the lower end 146. The cavity 137 may provide a path for air to travel therethrough. This air flow may assist in removing heat from the battery cell array 142.

The thermal plates 140 and 141 may each define one or more channels 160 extending along the exterior of the battery cell array 142 in a substantially horizontal fashion. The channels 160 may be arranged to thermally communicate with the battery cells 145 via the first faces 148 and the second faces 150. Examples of thermal communication may include conduction and convection. While the channels 160 are shown having a circular shape, it is contemplated that other shapes may be available for the channels 160. The number of channels 160 and their sizes may also vary according to packaging constraints and desired thermal management performance. The retainer segments 134 may each define one or more segment channels 161 which may extend along a portion of the upper end 144 and the lower end 146 of the battery cell array 142 to provide thermal communication thereto.

Inlet plenums 162 may be in fluid communication with the channels 160 of their respective thermal plates 140 and 141 to deliver thermal fluid thereto. Outlet plenums 168 may be in fluid communication with the channels 160 of their respective thermal plates 140 and 141 to remove thermal fluid therefrom. The inlet plenums 162 may be located opposite one another with respect to the battery cell array 142. The outlet plenums 168 may be located opposite one another with respect to the battery cell array 142. Inlet ports 170 may deliver thermal fluid to the inlet plenums 162. Thermal fluid may exit the outlet plenums 168 via outlet ports 171. The thermal plates 140 and 141 may also define the inlet ports 170 and the outlet ports 171. The orientation of the plenums and channels 160 may be such that thermal fluid flowing within the channels 160 will flow in opposite directions on either side of the battery cell array 142. This orientation may assist in maximizing overall heat transfer efficiency between the battery cell array 142 and the thermal plates 140 and 141 by minimizing cell ΔT and array ΔT of the battery cells 145 and the battery cell array 142, respectively.

The thermal plates 140 and 141 may contact the faces 148 and 150 of the battery cells 145. Additionally or alternatively, a thermal interface layer 172 may be located between the thermal plates 140 and 141 and the faces 148 and 150 of the battery cells 145. The layer of thermal interface material 172 may enhance heat transfer between the battery cell array 142 and the thermal plates 140 and 141 by filling, for example, voids and/or air gaps between the battery cells 145 and the thermal plates 140 and 141. Voids and/or air gaps may be the result of assembly and/or manufacturing variations. The thermal interface layer 172 may also provide electrical insulation between the battery cell array 142 and the thermal plates 140 and 141. As such, heat generated by the battery cells 145 may transfer to the thermal plates 140 and 141 and to the thermal fluid flowing within the channels 160.

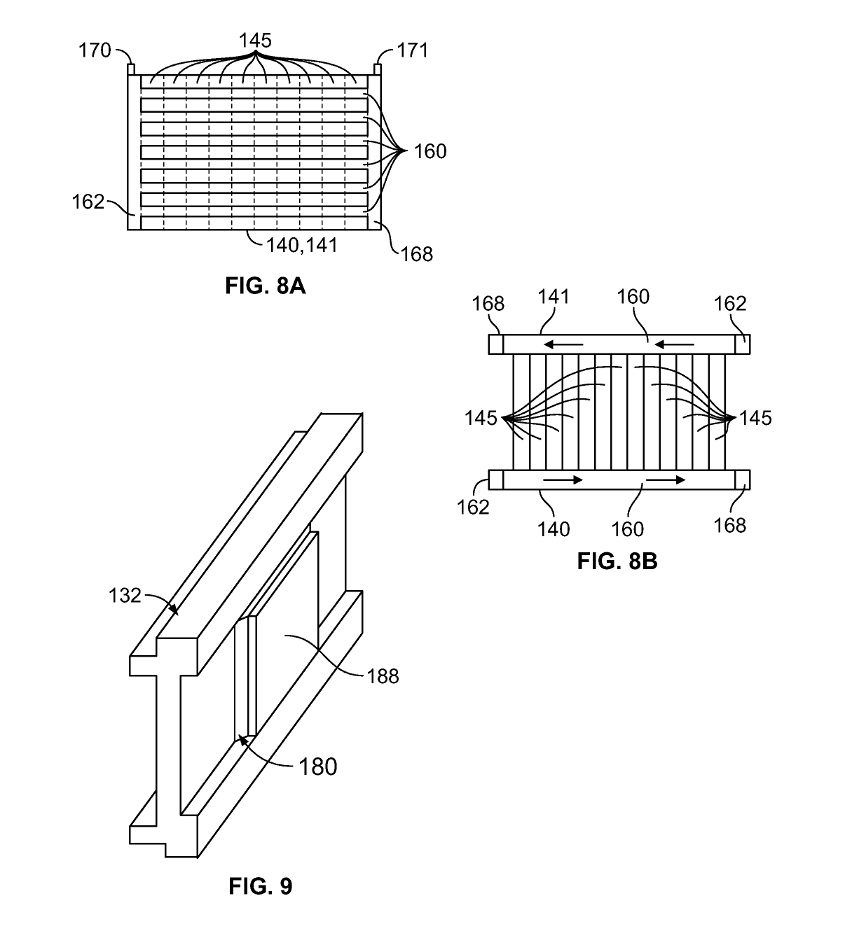

Now referring to FIGS. 7 through 8B, the thermal plates 140 and 141 and the retainer segments 134 may define one or more configurations for the channels 160 and the segment channels 161, respectively. These channels 160 and segment channels 161 may correspond to one or more battery cells 145 and assist in cooling the same. Walls defined by the thermal plates 140 and 141 may be shared between adjacent channels and also may provide a path for heat to travel through the thermal plates 140 and 141. For example, the channels 160 may be arranged within the thermal plates 140 and 141 to direct thermal fluid flow in opposite directions relative to one another and to extend along the faces 148 and 150. In this arrangement, each of the channels 160 may extend along a length of one of the side portions of the battery cell array 142, across a width of the faces 148 and 150, and be oriented substantially perpendicularly relative to a height of the battery cell array 142 as shown in FIGS. 8A and 8B. As another example, the segment channels 161 may be arranged within the retainer segments 134 to direct thermal fluid flow in opposite directions relative to one another and to extend along an outer portion of the upper end 144 and the lower end 146 of the battery cell array 142. In this arrangement, each of the segment channels 161 may extend along a portion of the upper end 144 and the lower end 146 of the battery cell array 142.

FIG. 9 shows yet another example of a channel configuration. In this example, the thermal plate 140 or 141 may include an extension plate 180. The extension plate 180 may include extension channels (not shown) which may be in fluid communication with the channels 160. A heat generating module 188 may be secured to the extension plate 180 and in thermal communication therewith. Thermal fluid flowing within the extension channels may assist in cooling the heat generating module 188. Examples of the heat generating module 188 may include a DCDC converter module, a BECM, and a charger.

The channels 160, segment channels 161, and extension channels may optionally be modified and/or turbulized to provide increased surface area which may also increase heat transfer efficiency. Turbulization involves the modification of a surface involved in a heat transfer process to intensify the heat transfer capabilities. Providing bumps and/or extrusions to a thermal flow field may be one example of turbulizing the thermal flow field surface. Additionally, at least some of the surfaces of the channels 160 and 161 may include flow features configured to increase an effective surface area of the channels. For example, the flow features may include brazed split fins, brazed metal foam such as Aluminum, extrusions, dimples, or pedestals in the bottom plate. These features may also assist in transferring more heat to the thermal plates 140 and 141.

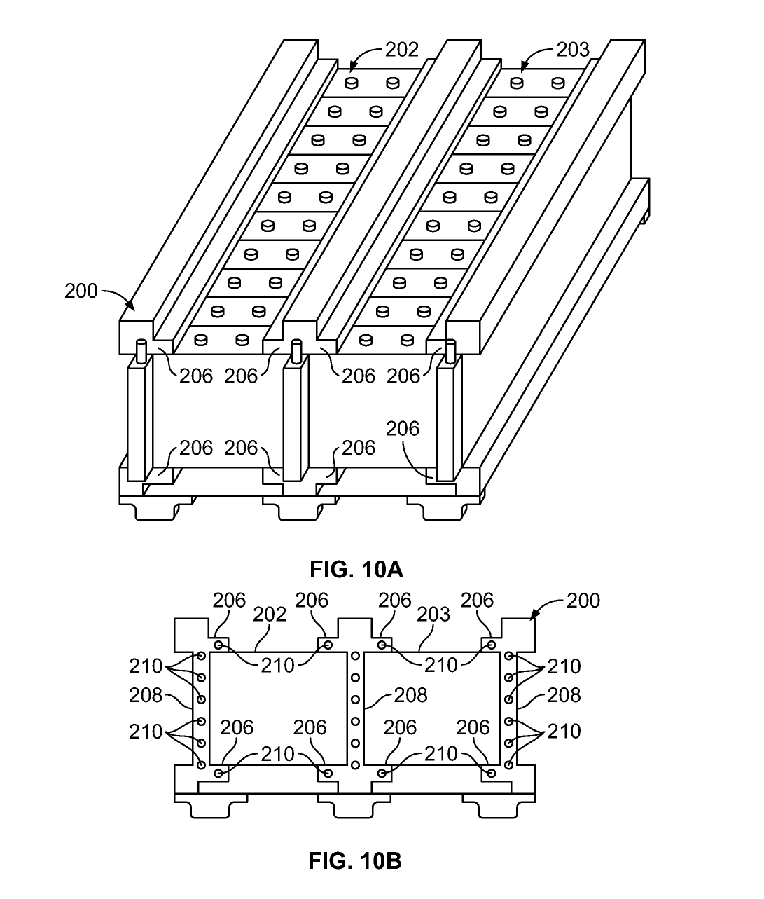

Referring now to FIGS. 10A and 10B, another exo-support structure 200 is shown which may include a battery cell array 202 and a battery cell array 203. The exo-support structure 200 may be a single component or may be two separate components. As with the exo-support structure 132, the exo-support structure 200 may include retainer segments 206. Thermal plates 208 may be included within or defined by the exo-support structure 200 and be in thermal communication with the battery cell arrays 202 and 203. The retainer segments 206 and the thermal plates 208 may include a plurality of channels 210 configured to direct thermal fluid flow along the battery cell arrays 202 and 203. In this example, the battery cell arrays 202 and 203 may be arranged relative to one another such that one of the thermal plates 208 is in thermal communication with both the battery cell arrays 202 and 203.

As described above, in a liquid thermal management system heat transfer typically occurs from the battery cell to the thermal fluid and then to the thermal plate. Maximizing contact surfaces of the battery cell and thermal plate may increase efficiency of the thermal management system. One example of maximizing contact surfaces includes providing thermally conductive interfacing materials located between the battery cells and in thermal communication with the thermal plates.

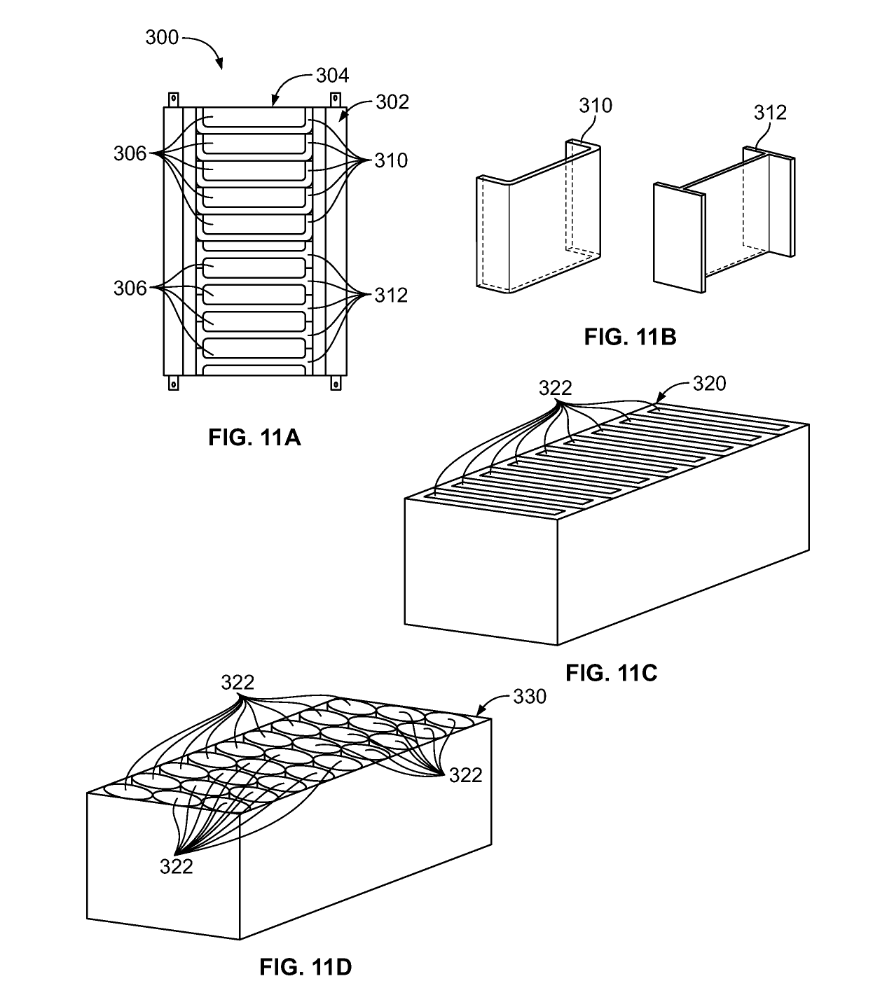

Referring now to FIGS. 11A and 11B, an example of a traction battery assembly 300 is shown. The traction battery assembly 300 may include an exo-support structure 302 which is configured to support a battery cell array 304 which includes plurality of battery cells 306. Either cell separators 310 or cell separators 312 may be located between adjacent battery cells 306. The cell separator 310 may be configured to contact two adjacent battery cells 306 on three sides and at portions of the battery cells 306 which do not include an upper end and a lower end. The cell separators 310 may be C-shaped such that portions of the cell separators 310 contact one or more thermal plates within the exo-support structure 302. The cell separators 312 may be configured to contact two adjacent battery cells 306 on three sides and at portions of the battery cells which do not include the upper end and the lower end. The cell separators 312 may be I-shaped such that portions of the cell separators 312 contact one or more thermal plates within the exo-support structure 302. The cell separators 310 and 312 are both shown in traction battery assembly 300 for illustrative purposes. Most likely, packaging constraints will drive a determination of a single type of cell separator to use within the thermal management system. The cell separators 310 and 312 may assist in electrically isolating adjacent battery cells 306 from one another. The cell separators 310 and 312 may be made of a thermally conductive material to assist in dissipating heat from the battery cells 306. For example, the cell separators 310 and 312 may be made of a ceramic doped high density polyethylene or polypropylene. The cell separators 310 and 312 may also be made of aluminum coated with ceramics and/or laminated with film.

In another example as shown in FIG. 11C, a cell separator 320 may be a single block configured to sit within the traction battery assembly 300. The cell separator 320 may define slots 322 to receive the battery cells 306. The cell separator 320 may be configured to contact each of the battery cells 306 on three sides which do not include the upper end and lower end. The cell separator 320 may assist in isolating adjacent battery cells 306 from one another. The cell separator may be made of a thermally conductive material to assist in dissipating heat from the battery cells 306. For example, the cell separator 320 may be made of a ceramic doped high density polyethylene or polypropylene.

In yet another example as shown in FIG. 11D, a cell separator 330 may be a single block configured to sit within the traction battery assembly 300. The cell separator 330 may define a plurality of cylindrical slots 332 to receive cylindrical battery cells (not shown). The cell separator 330 may be configured to contact an outer surface of the cylindrical battery cells. The cell separator 330 may assist in isolating adjacent cylindrical battery cells from one another and may be made of a thermally conductive material to assist in dissipating heat from the cylindrical battery cells. For example, the cell separator 330 may be made of a ceramic doped high density polyethylene or polypropylene. It is contemplated that these types of cell separator blocks may have alternatively shaped slots to receive other types of battery cells including but not limited to pouch battery cells.

As described herein, mounting thermal plates on either side of a battery cell array may provide increased surface contact area with the battery cells when compared to a thermal management system in which the thermal plate is positioned below the battery cell array. When using two thermal plates, one common design may be used for both to assist in minimizing development and tooling costs. The two thermal plates may also assist in retaining the cells and providing structural rigidity to the traction battery assembly. The retainer segments may also assist in retaining the cells and providing additional channels proximate to the battery cells for thermal fluid to flow therethrough. Including thermally interfacing cell separators between adjacent battery cells may further assist in dissipating heat from the battery cells.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A battery assembly comprising:
an array of cells each having upper and lower ends, a face extending therebetween and partially defining an exterior of the array, and terminals extending from the upper end; and
an exo-support structure including a plurality of retainer segments configured to support the ends and a thermal plate defining one or more channels extending along the exterior of the array and arranged to thermally communicate with the cells via the faces.

2. The battery assembly of claim 1, further comprising a thermal interface layer disposed between and in contact with the faces and thermal plate.

3. The battery assembly of claim 1, wherein the thermal plate directly contacts the faces of the cells.

4. The battery assembly of claim 1, wherein at least one of the retainer segments defines a segment channel therein which extends along a portion of the ends that does not include the faces.

5. The battery assembly of claim 1, wherein each of the cells has another face extending between the upper and lower ends, opposite the other face, and partially defining another exterior of the array, and wherein the exo-support structure further includes another thermal plate defining one or more channels extending along the another exterior of the array and being arranged to thermally communicate with the cells via the another face.

6. The battery assembly of claim 1, further comprising at least one cell separator made of a thermally conductive material which is located between two adjacent cells and configured to contact the two adjacent cells at portions of the cells on three sides which do not include the upper and lower ends and to dissipate heat therefrom.

7. The battery assembly of claim 6, wherein the thermally conductive material is made of ceramic doped high density polyethylene or polypropylene, or of an aluminum coated with ceramics or laminated film.

8. A vehicle comprising:
a battery cell array having two side portions;
two thermal plates, each in thermal communication with the battery cell array on opposite side portions of the array and each defining a plurality of substantially horizontal channels relative to the array therein;
an extension plate including at least one extension plate channel in fluid communication with at least one of the substantially horizontal channels;
a heat generating module in electrical communication with the array and secured to the extension plate and in thermal communication therewith; and
an exo-support structure configured to support the array and to house and orient the thermal plates such that each of the substantially horizontal channels extend along a length of one of the side portions of the array.

9. The vehicle of claim 8, further comprising a thermal interface layer disposed between and in contact with at least one of the side portions and thermal plates.

10. The vehicle of claim 8, further comprising at least one cell separator made of a thermally conductive material which is located between two adjacent battery cells and configured to contact three sides of one of the battery cells such that heat is dissipated therefrom and toward the thermal plates.

11. The vehicle of claim 8, wherein the exo-support structure defines a plurality of retainer segments configured to support the array and wherein the retainer segments define at least one retainer channel therein and are arranged such that the at least one retainer channel extends along a portion of an upper or lower end of the array.

12. The vehicle of claim 8, further comprising a battery tray configured to support the exo-support structure, and wherein a bottom portion of the array, the support structures, and the battery tray define a cavity such that air may flow underneath the array.

13. The vehicle of claim 8, wherein each of the thermal plates defines inlets in communication with the channels and wherein the thermal plates are arranged such that the inlets are at opposite ends of the array.

14. A battery thermal management system comprising:
a battery cell array including battery cells;
two thermal plates located on either side of the array and each defining an inlet port and an outlet port positioned at opposite ends of the respective thermal plate, and a plurality of channels each including an inlet in communication with the inlet port and an outlet in communication with the outlet port; and
an exo-support structure configured to house the two thermal plates and to support the array, the plates and structure being arranged such that the channels extend along a width of each outer face of the battery cells and are substantially perpendicular to a height of the array.

15. The system of claim 14, wherein one of the thermal plates further defines an extension plate including a plurality of extension plate channels in fluid communication with at least one of the plurality of channels and configured to thermally communicate with a heat generating module secured thereto.

16. The system of claim 14, further comprising another battery cell array supported by the exo-support structure and arranged with the other battery cell array such that one of the thermal plates is arranged therebetween and in thermal communication with both battery cell arrays.

17. The system of claim 14, further comprising a plurality of cell separators made of thermally conductive materials located between adjacent battery cells and being configured to contact three sides of one of the adjacent battery cells and dissipate heat therefrom.

18. The system of claim 17, wherein the cell separators are C-shaped or I-shaped.

19. The system of claim 14, further comprising a cell separator block made of a thermally conductive material and being configured to sit within the exo-support structure and defining a plurality of slots arranged to receive the battery cells.

20. The system of claim 14, wherein the exo-support structure defines a plurality of retainer segments configured to support the array and wherein the retainer segments define at least one retainer channel therein and are arranged such that the at least one retainer channel extend along a portion of an upper or lower end of the array.
